(19) United States
(12) Patent Application Publication
(10) Pub. No.: US 2006/0000911 A1
(43) Pub. Date: Jan. 5, 2006

(54) Automatic certification, identification and tracking of remote objects in relative motion

(76) Inventor: Amit Stekel, Pardes-Hanan (IL)

Correspondence Address: Amit Stekel, Heasis 3/17, Pardes-Hana, 37084, IL

(21) Appl. No.: 10/513,886

(22) PCT Filed: May 9, 2003
(86) PCT No.: PCT/IL03/00378

§ 371 Date: Nov. 9, 2004

Related U.S. Application Data
(60) Provisional application No. 60/378,768, filed on May 7, 2002.

(51) Int. Cl. G02B 5/00; G06K 7/10

(52) U.S. Cl. 235/462.32

(57) ABSTRACT

A method and apparatus for automatic certification, identification and tracking of remote objects in relative motion to a reading system, utilizing a novel tag affixed to an object and novel apparatus and techniques for automatically reading the tag information, its relative velocity, angle and position. The tag reader comprises an imaging system that undertakes real time image processing of the acquired images. Matching of the optical parameters of the imaging optics at the reader and the focusing optics at the tag ensure optical reliability and readability at large ranges. Novel types of tag designs are presented.

### FIELD OF THE INVENTION

The present invention relates to the field of remote tracking systems, especially for use in determining the identity and motion of a moving remote object by means of an optical identity tag carried thereon.

### BACKGROUND OF THE INVENTION

Various systems are known in the prior art that address the problem of automatically identifying tagged objects or vehicles in motion. These systems generally use radiation such as ultrasonic, radioactive, optical, magnetic or radio frequency radiation. Some of these systems have not received widespread acceptance because of excessive cost and insufficient reliability.

Various optical systems, such as license plate recognition systems, are sensitive to lighting variations, cannot handle massive flows and necessitate the assistance of a human operator to analyze cumbersome images of license plates that the processing software cannot recognize. Other optical systems, based on barcode reading, generally have limited contrast and spatial resolution. Commonly used barcode systems based on laser scanning are generally limited to static or quasi-static situations; in dynamic situations, where the barcode is in motion, the signals tend to smear and the resolution is degraded. Normal barcode systems are also limited to close proximity between the scanner and the barcode; at large distances, the spatial resolution is again degraded because of insufficient sampling. Yet another problem arises from the fact that the field of view of prior art, conventional barcode systems is limited to the collimated beam zone; thus the operator needs to find the optimal location of the scanner in front of the barcode, which can be a time-wasting operation. Other barcode systems adapted for large distances and high velocity reading capabilities either necessitate relatively large barcode patterns or special means to magnify the barcode patterns using special optics. These systems are complex; and may have a tendency to malfunction, or may be sensitive to harsh reading conditions. Furthermore, for use with high object velocities they tend to provide smeared signals.

U.S. Pat. No 6,017,125 to Vann discloses the use of a bar coded retroreflective target to measure six degrees of target position and the use of a bar coded retroreflector to provide information about the target. These designs use the object motion to scan a barcode pattern that is combined with retroreflective optics, either a cube retro reflector or a ball lens retro reflector. In addition, the designs disclosed in this patent are bulky, are probably costly to manufacture, and thus may not be suited for mass usage.

Furthermore, in the system described by Vann, the entire field of view of the object or objects being scanned or tracked are described as being focused onto the detector, which is alternatively described as being either a position sensitive detector, or an array of photodiode elements or a camera. The decoding of the information is determined by signal processing of the time-varying digital signals obtained from these detectors. As a result, since all of the sensors of the detection means respond to all of the tags within the reader's viewing field at any given time, it is not possible to separate between multiple responses of several tags that may appear in the volume monitored, and the method thus would appear to suffer from tag cross talk Tracking of more than one tag at a time would thus appear to be difficult using this prior art apparatus.

There are yet other types of system that use radio frequency waves, namely radar devices. These systems installed in urban vicinities are restricted by radiation regulations and necessitate an authority license for operation. In a lot of cases, this limits their maximum power to relatively low levels. This in turn, narrows the communication zone and worsens the electromagnetic interference noise situation, resulting in a poor signal-to-noise ratio. Furthermore, radio frequency based systems are susceptible to inter-modulation or cross talk between tags that may be addressed at the same moment in time. Finally, in applications where the position and speed are desired in addition to the vehicle identity, radar devices tend to confuse between neighboring vehicles.

### SUMMARY OF THE INVENTION

The present invention seeks to provide a method and apparatus for automatic certification, identification and tracking of remote objects in relative motion to a reading system, and in particular a system comprised of a novel tag affixed to an object and novel apparatus and techniques for automatically reading the tag information, its relative velocity, angle and position. The relative motion between the reader and the tag may occur in either one of three situations: (i) a stationary reader and moving tag; (ii) a stationary tag and moving reader, as in a scanning detector; and (iii) a situation with both tag and reader moving in relative motion to each other. The system has particular application to the problem of vehicle identification, as well as the measurement of their speed and position simultaneously. Another application of the system of the present invention is for the provision of automatic and maintenance-free road signposts, where signpost data could be read from a moving vehicle and from a remote distance. Yet another application is the scanning of inventory in places such as warehouses, museums etc., where readers are installed on entrances, or may be conveyed on rail arrangements so as to scan each tagged item swiftly.

The present invention attempts to overcome the difficulties associated with prior art systems, as outlined in the Background section, by providing a novel optically readable system and method for the remote identification of objects in relative motion, such as vehicles, in addition to speed and position determination.

The system preferably comprises a separate reader unit and an optical tag unit, preferably on the moving object. The system generally comprises a light source that is preferably monochromatic, an imaging device having its optical axis and field of view exactly bore sighted with the light source, and a retroreflective tag preferably attached to the moving object. The system differs from the prior art systems described above, in that the field of view of the reader unit is imaged by the detection means, preferably a video imager, such that a complete image of the entire field of view is captured at every moment. This image, which can contain retro-reflected information from multiple tags, can be processed by means of standard image processing techniques, and temporally changing information about each tag extracted separately on each pixel, without any confusion or mixing between different tags. In the prior art system of Vann, for instance, light returning from the retro-reflector is not described as undergoing any real imaging process, but is shown as being focused onto the detector plane only by means of a cylindrical lens, which is described alternatively either as compensating the divergence of the light returning from the retro-reflector, or as focusing the returning beam on the detector, in locations that are proportional to the vertical angle. From the description given, it would thus appear that retro-reflected light from a number of tags spaced in the direction of the scanning or the motion would be focused onto the detector plane without the use of an imaging lens, which may cause a smearing of the tag differentiation.

Yet another object of the present invention is to provide for a system and a tag that can be read at high relative velocities. As will become apparent from the detailed description of the construction and operation of the reading apparatus and tag, the optical tag uses optical elements to image the information plane of the tag, preferably a barcode, back to the reader unit aperture plane, and uses the tag's motion to scan the tag's information plane, such that the spatial information contained in this plane is transformed to a temporal scanning signal that can be acquired by the reader's video imager.

In accordance with a first aspect of the invention, the present invention provides a maintenance free and low-cost optical tag that use retroreflective means to reflect and modulate the reader's light, back to the reader's imaging device, without the need for an internal source of energy.

In accordance with a second aspect of the invention, the present invention provides a method and a system that can automatically detect and identify a remote tag in relative motion to the scanner, utilizing the tag's unique spatio-temporal features as a trigger for the reader activity.

In accordance with a third aspect of the invention, the present invention provides a system that can be used in severe lighting conditions, utilizing a retroreflective tag that, together with an active illumination with monochromatic light and a suitable filtered imaging device, can suppress spurious light sources and enhance the tag reflective light.

In accordance with a fourth aspect of the invention, the present invention provides a system that can be read from relatively large distances, utilizing a retroreflective tag and a bore sight arrangement of the reader's light source and the reader's imaging device.

In accordance with a fifth aspect of the invention, the present invention allows for simultaneous identification and measurement of speed and position of multiple moving objects or vehicles. As will become apparent from the detailed description of the construction and operation of the optical tag reading apparatus, the system allows for multiple reading of neighboring tags with negligible cross talk between them such that even high flows of moving objects or high traffic flows can be read successfully without degradation in system performance.

In accordance with a sixth aspect of the invention, the present invention provides means to handle dirt and smudge in the optical path, by locating the tag near the front windshield of a vehicle, so that if it is covered, the driving visibility will also be degraded and steps taken to rectify the situation.

In accordance with a seventh aspect of the invention, the present invention provides for covert operation using light in the infrared region. In addition, as the method is based on a retro reflected radiation the tag can be detected from the reader alone and no light is scattered to another directions.

In accordance with an eighth aspect of the invention, the present invention provides for automatic and remote certification of tagged objects using special optical means to prevent counterfeiting.

In accordance with a ninth aspect of the invention, the present invention provides for the production of a cost effective, thin and lightweight tag that can be affixed easily to various objects.

In accordance with a tenth aspect of the invention, the present invention provides for cost effective ways for the production of the proposed tag.

In accordance with an eleventh aspect of the invention, the present invention provides for scanning schemes that reduce the geometrical limitations of the tag reading.

Other objects and advantages of this invention will become apparent as the description proceeds.

The disclosures of all publications mentioned in this section and in the other sections of the specification, and the disclosures of all documents cited in the above publications, are hereby incorporated by reference, each in its entirety.

### BRIEF DESCRIPTION OF THE DRAWINGS

Non-limiting examples of embodiments of the present invention are described below with reference to figures attached hereto and listed below. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

For fuller understanding of the objects and aspects of the present invention, preferred embodiments of the invention are described with reference to the accompanying drawings, which show in:

FIG. 1: An illustration of a first embodiment of the moving tag reader apparatus, i.e. an MTR, in accordance with a preferred embodiment of the present invention;

FIG. 2A: An illustration of an optional embodiment of the moving tag reader apparatus, i.e. an MTR, using fiber optics located at the center of the lens, in accordance with another preferred embodiment of the present invention;

FIG. 2B: An illustration of an optional embodiment of the moving tag reader apparatus, i.e. an MTR, using fiber optics on the lens optical axis, in accordance with another preferred embodiment of the present invention;

FIG. 2C: A side view of an optional embodiment of the moving tag reader apparatus, i.e. an MTR, using light sources distributed around the camera lens, in accordance with another preferred embodiment of the present invention;

FIG. 2D: An upper view of an optional embodiment of the moving tag reader apparatus, i.e. an MTR, using light sources distributed around the camera lens, in accordance with another preferred embodiment of the present invention;

FIG. 3A-C: A schematic illustration relating to the temporal aspects of the invention, showing the various phases of operation of the invention, in accordance with another preferred embodiment of the present invention;

FIG. 4A, B: illustrations of an optional embodiment of the reader and tag where the moving tag is read by a multi directional scanning system, in accordance with another preferred embodiment of the present invention;

FIG. 5: illustrations of optional embodiments of the reader and tag where the moving tag is read from an arbitrary direction using a Circular Barcode pattern, in accordance with another preferred embodiment of the present invention;

FIG. 6: illustrations of an optional embodiment of the tag, where the focusing optics is constructed of a lenslet array such as a Diffractive Optical Element (DOE) Array, in accordance with another preferred embodiment of the present invention;

FIG. 7: A detailed illustration of an optional embodiment of the optical tag, where the tag information plane is curved along a sphere, in accordance with another preferred embodiment of the present invention;

FIG. 8A, B: illustrations of an optional embodiment of the tag, where the tag retro-reflection is enhanced, in accordance with another preferred embodiment of the present invention;

FIG. 9: illustrations of an optional embodiment of the tag, where the tag is constructed of a single surface DOE, in accordance with another preferred embodiment of the present invention;

FIG. 10: An overall illustration of a preferred embodiment of the invention being used to identify moving objects, in accordance with another preferred embodiment of the present invention;

FIG. 11A: A schematic illustration of the scene viewed by the reader's imager, showing the tagged objects or vehicles in motion, in accordance with another preferred embodiment of the present invention;

FIG. 11B: A schematic illustration relating to the filtered image acquisitioned by the reader's video imager showing the tags' retroreflective responses, in accordance with another preferred embodiment of the present invention;

FIG. 12: A schematic illustration depicting the process of accumulating the tag data in the reader, in accordance with another preferred embodiment of the present invention; and

FIG. 13: A block diagram depicting code and data flow of the signal processing process, in accordance with another preferred embodiment of the present invention.

### DETAILED DESCRIPTION OF PREFERRED EMBODIMENTS

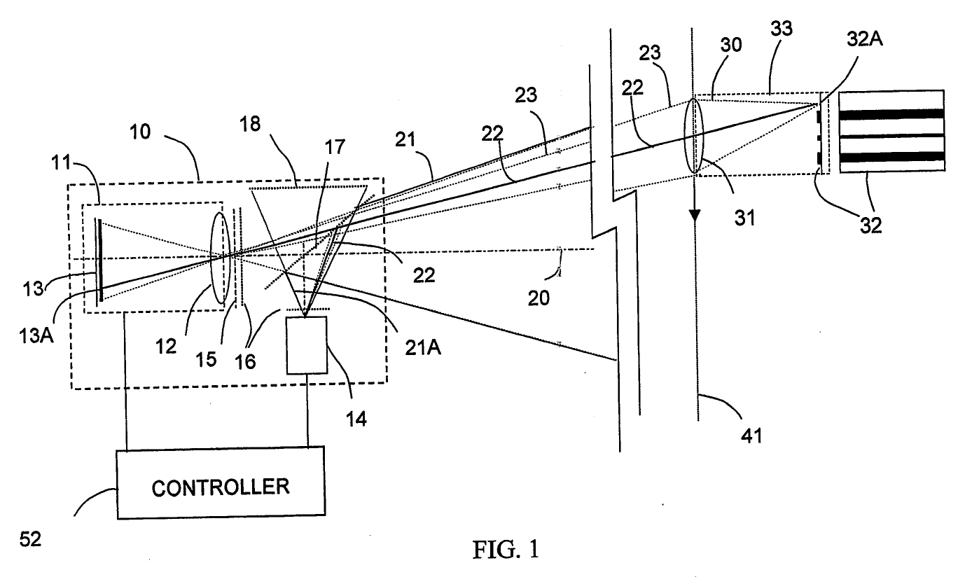

FIG. 1 shows a schematic layout of the system of the present invention comprising a moving tag reader, (MTR), 10, for automatic identification, speed assessment and position determination of moving tags, in accordance with a preferred embodiment of the present invention. The MTR 10 optionally comprises a camera 11 having a lens 12 and an imager 13, a light source 14 and a beam splitter 17. A controller 52 controls the light source 14 and camera 11 and also preferably comprises an image processor for processing images acquired by the camera of the entire field of view of the MTR In accordance with an embodiment of the present invention, light source 14 and camera 11 optionally have coincident optical axes 20 by means of a bore sight arrangement using beam splitter 17, and optionally have the same field of view 21 by suitable choice of the numerical aperture of the lens 12 and the cone of light 21A emitted by the light source. The light source can preferably be either a regular lamp source emitting a diverging beam to cover the desired field of view, or a laser source emitting a coherent beam, together with a negative lens for providing a sufficiently diverging beam if the laser is too collimated.

In FIG. 1, a tag 30, installed on a moving object, such as a vehicle, is comprised of a lens 31 and an information plane, 32. In accordance with a preferred embodiment of the present invention, the tag 30 and the MTR 10 are optionally arranged to have the same depth of field and the same field of view by appropriate choice of the parameters of lens 12 and lens 31 and the distances of their imaging planes 13 and 32 from their respective lenses. This assures that the MTR and tag are optimally optically coordinated to work together, having both optimal visibility and resolution.

A light ray, 22A, emitted from light source 14 is reflected from the beam splitter 17 to the direction of the tag as light ray 22. Any light ray in the cone 23, including light ray 22, is eventually focused to the same focus point 32A in the tag information plane 32. In turn, part of the light from the focal point 32A is reflected through the light cone 33 back to the entrance pupil of the tag lens 31, focused back to the direction of the MTR 10, transmitted through the beam splitter 17, enters the camera lens 12 entrance pupil and is imaged to the point 13A on the imaging plane 13 of the camera 11. This tag configuration is called a “retro reflector” because it retro reflects any beam in its entrance pupil back to its original direction. In addition to retro reflecting, the tag configuration has the useful feature of focusing the beam back to its point of origin, which in the layout described in FIG. 1 is co-aligned with the camera entrance pupil. These features of the tag are the most advantageous arrangement to conserve energy and maximize efficiency of the reflected light that enters the camera's entrance pupil 12.

In accordance with another preferred embodiment of the present invention, the information plane 32 is optionally comprised of a retro reflective sheet. In this way the tag reflecting efficiency is enhanced because most of the light rays incident on the focus point 32A is reflected back to the tag lens 31 entrance pupil.

Furthermore, according to another preferred embodiment of the MTR of the present invention, there is shown in FIG. 1 an optional chromatic filter 15 and two aligned polarizers 16. These optional means are useful for enhancing tag response and rejecting responses from spurious sources. In this optional embodiment, the color filter 15 is matched to a monochromatic light source 14 and the two linear polarizers are aligned so that light coming out of the light source 14 can reach the camera 11 with minimal interference and light coming from other light sources, such as sunlight reflections or vehicle lights, is reduced substantially.

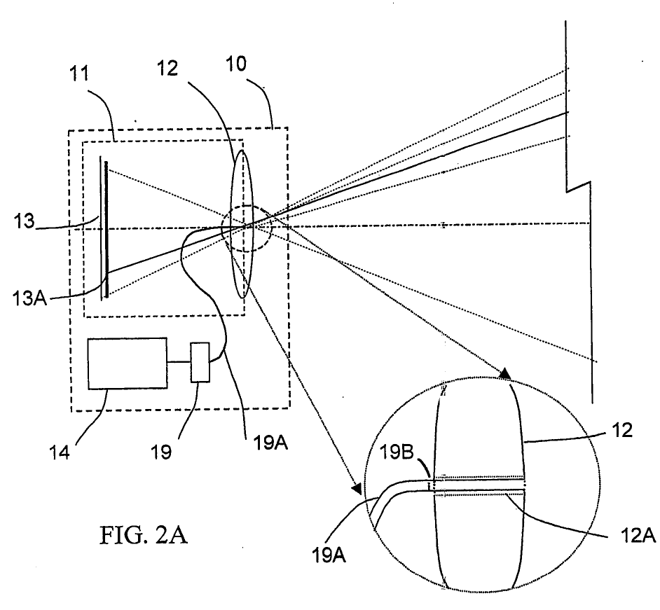

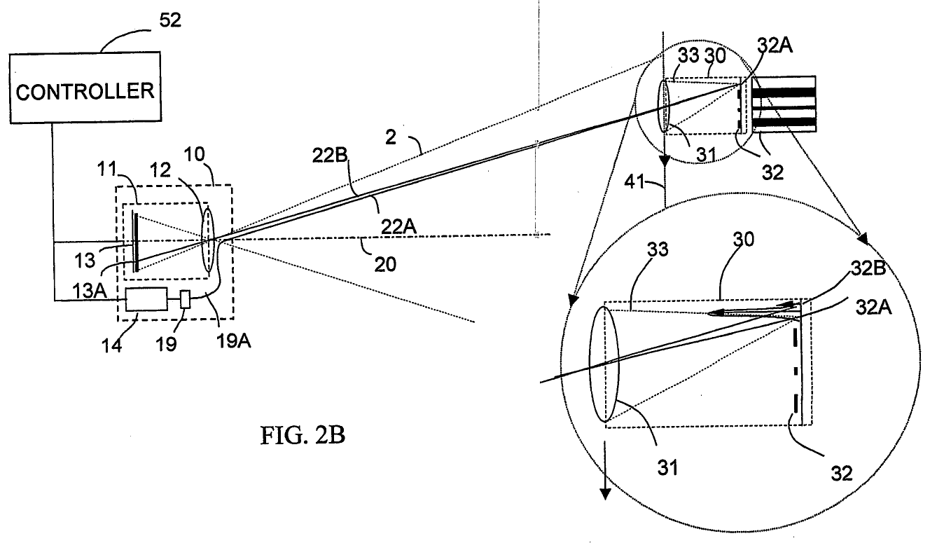

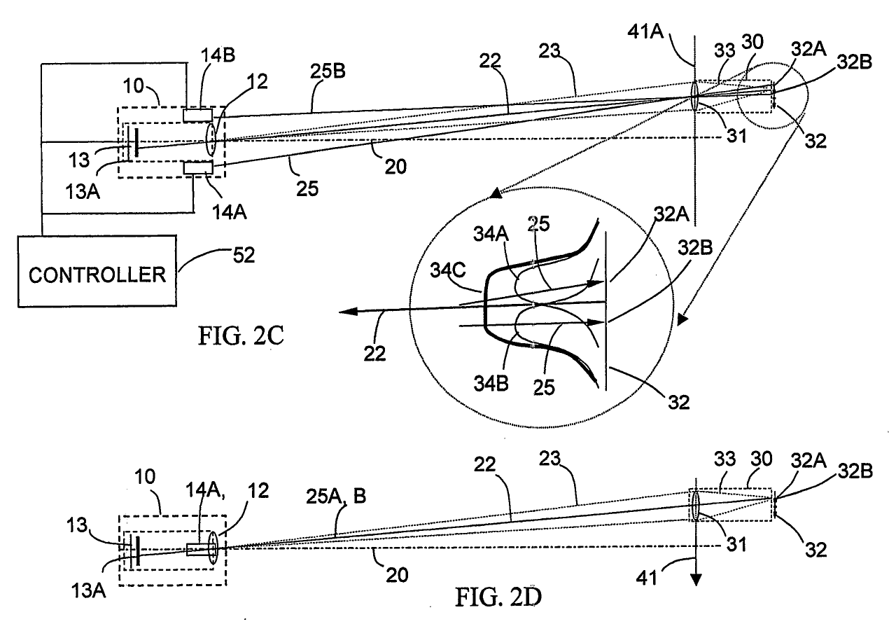

FIG. 2A shows another preferred embodiment of the MTR of the present invention, in which the light source, 14, is collimated by means of a single-fiber collimator 19 into an optical fiber, 19A. The end of the fiber is optionally inserted into a hole, 12A, in the imaging lens, 12. Alternatively and preferably, the fiber end can be disposed behind the lens center, at 19B, such that the combined numerical aperture of the paraxial portion of the lens and fiber is essentially the same as that of the full aperture of the lens. The lens hole 12A, is then unnecessary.

As another option to FIG. 2A, typical of high numerical aperture applications, FIG. 2B shows yet another preferred embodiment, in which the end of the fiber is optionally fixed in front of the lens, 12, co aligned to its optical axis, 20. In these cases the parallax between the light coming out of the fiber, 22A, and the retro reflected light collected by the imaging lens, 22B, is negligible.

FIGS. 2C and 2D show a side view and an upper view, respectively, of another preferred embodiment of the MTR of the present invention, in which a number of light sources are distributed around the imaging lens, 12. Such an embodiment may be realized using a ring of LED's placed around the lens. FIG. 2C, shows a side view of a particular distribution, where two light sources, 14A and 14B, are located on two sides of the imaging lens, 12, in a perpendicular direction to the scanning direction.

The beams 25A and 25B, coming of the light sources 14A and 14B respectively, are focused on 32A and 32B, respectively, on the information plane, 32 of the tag, 30. The two focuses have point spread functions, 34A and 34B, accordingly and thus a combined response 34C that in turn is retro reflected in a direction surrounding the direction 22, back to the MTR entrance pupil. FIG. 2D, shows an upper view of this embodiment, where the two point spread functions are located on the same vertical location along the scanning direction.

This embodiment of the MTR is typical of applications where the numerical aperture is especially high, and enables the parallax between the light coming out ring of LED's and the retro reflected light collected by the imaging lens, 12, to be negligible.

In accordance with an embodiment of the present invention, the information plane 32 optionally comprises a barcode pattern having its chief axes, i.e. the scan axes, co aligned with the direction of the object motion.

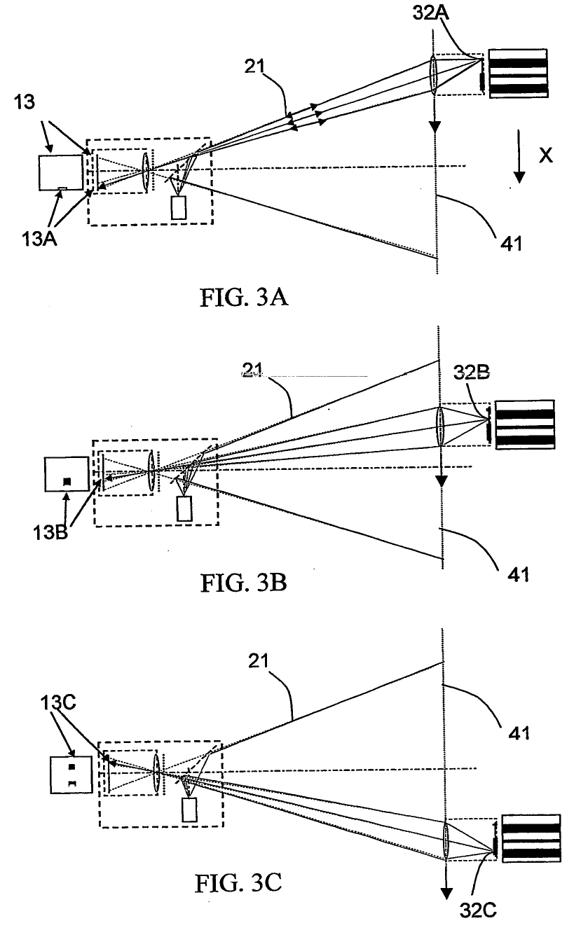

Reference is now made to FIGS. 3A-C that are a series of sequential schematic illustrations, showing the motion of a tagged object 40 across the field of view of the reader unit 10, in accordance with another preferred embodiment of the present invention. The drawings illustrate graphically the way in which the spatially moving information on the tag 30 is transformed into meaningful and simply read temporal information by means of the optics of both the tag unit 30 and the reader unit 10. In FIG. 3A, the tagged object 40 is shown entering the field of view of the reader unit 10, at which point, the mutual geometries of the imaging optics of reader and tag units are such that the first bar of information 32A on the tag information plane 32 retro-reflects the incident illuminating beam and is imaged by the read unit on the camera image plane 13 as point 13A. As the tagged object moves along its motion path 41, the mutual fields of view of the reader and tagged units change such that retro-reflected rays from different bars of the tag are sequentially imaged onto the camera image plane. Thus, in FIG. 3B, bar 32 B is imaged onto point 13B on the camera imaging plane, and in FIG. 3C, the bar at 32C is imaged onto point 13C by the camera. In this way, the entire bar code information is sequentially imaged onto the camera image plane 13 such that the system controller acquires a temporally changing image of the tag information.

In some prior art barcode scanning systems, a collimated laser beam, swept across the bar-code, is used in order to convert the spatial information on the bar code into temporally changing information for serial processing. The system of the present invention differs from this prior art in that the optics incorporated on the tag enlarge each bit of the information plane so that it is fully resolved by the reader even at substantially large distances, such that the tag may be kept relatively small.

Furthermore, the system of the present invention differs from such prior art in that the effective scanning motion of the interrogating illuminating beam across the bar-code, and its retro-reflected information-bearing beam, are generated by means of the relative motion of the limited fields of view of both reader and tagged units resulting from the use of the pre-specified optical imaging systems on both of these units. Thus there is no smearing of the signal read, which can cause the degradation of signal resolution.

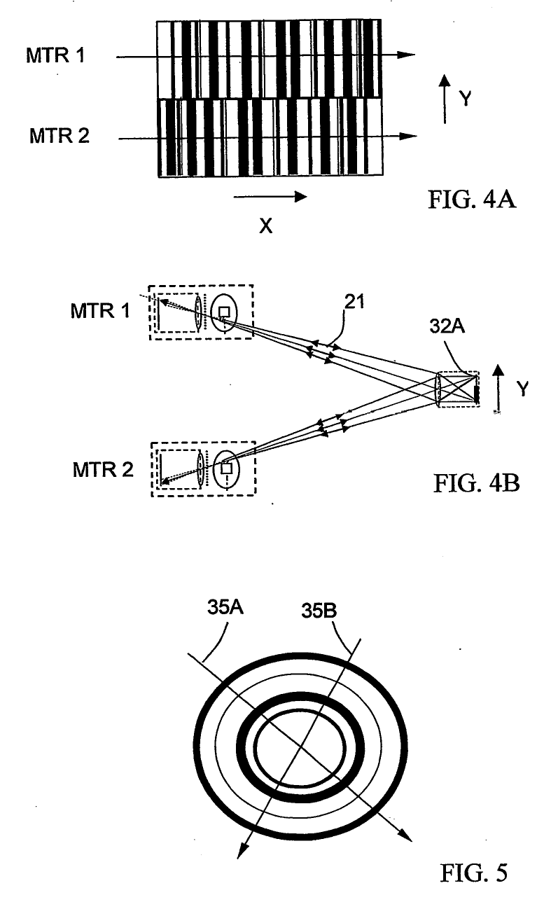

Reference is now made to FIGS. 4A to 5 where various optional configurations for different geometrical readings of the tag are shown.

FIGS. 4A and B: illustrate an optional preferred embodiment of the reader and tag where the moving tag is read by a multi-directional scanning system, in accordance with an embodiment of the present invention. In this configuration the tag information plane is optionally constructed of several barcode segments. Without losing generality, FIG. 4A represent the case of two separate barcodes located in the tag's information plane. The barcodes are located in different locations along the Y-axis, perpendicular to the reading direction, X. Alternatively and preferably the tag can comprise two identical barcodes to provide increased reliability by redundancy.

FIG. 4B shows two readers positioned in the appropriate angles, each of them reading the corresponding barcode segment.

FIG. 5 illustrates an optional embodiment of the reader and tag combination, where the moving tag is read from an arbitrary direction using a Circular Barcode pattern, in accordance with another preferred embodiment of the present invention; this optional configuration is suggested for situations where there is no guarantee that the barcode segment in the tag's information plane is aligned to the reading direction but it certain that the tag path is crossing through the reader's optical axis. Thus, independently of whether the tag is read along direction 35A or 35B, for instance, the information thereon is correctly imaged and decoded.

In accordance with another preferred embodiment of the present invention, the tag angle versus the reader optical axis direction may be recovered using the tag's reflected color. This feature is made possible by using a multicolored plane of information, 32, where each point on the plane features a unique color corresponding to a distinct angle of view. Having in advance knowledge of the information plane color scheme enables the retrieving of the tag angle versus the reader's optical axis direction, by identifying the tag retro reflection color. In that case, the reader may optionally be a multi spectral reader such as color video camera In accordance with another preferred embodiment of the present invention, the tag's position is related to its image in the reader's imaging plane and the velocity of the tag can be recovered by temporal derivation of the tag's position vector. Using features such as angle, position and velocity the tag can be traced or even may be used as a reference for automatic navigation.

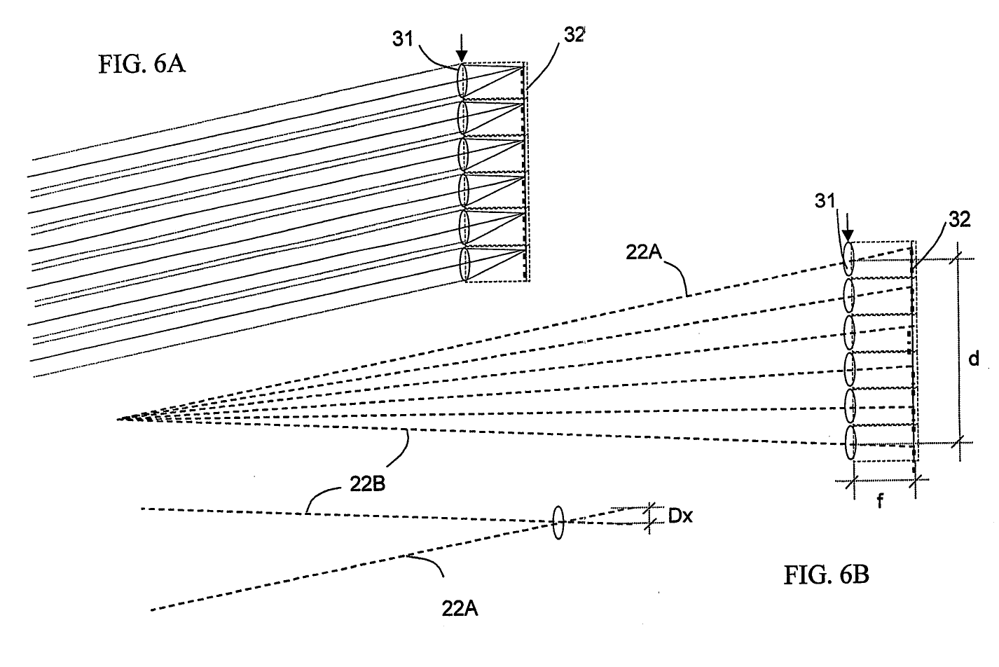

FIG. 6A shows another preferred embodiment of the tag, where the focusing optics is constructed of a Lenslet Array 31, in accordance with an embodiment of the present invention; this embodiment is useful whenever a lightweight and thin tag is desired. The number of array cells used is dependent on the reading distance of the application, the light power needed and the reading resolution available.

As an optional preferred embodiment, the lenslet array 31 can be created of a Diffractive Optical Element (DOE) Array. DOE's are particularly adaptable for monochromatic illumination and imaging systems and can incorporate corrections for spherical aberrations.

The information plane of the tag array is constructed of a periodical pattern having the same period as the optical array. The fitting of the periodical pattern can be done in numerous ways. One way is by printing a marker in a known location within the pattern and inserting the pattern into the optical array using an automated bench, having an optical feedback mechanism.

As an alternative option, the fitted pattern in the optical array can be left unaligned. In this case the optical marker can be identified with the reader in real time, thus the read barcode pattern can be prearranged in a cyclic manner.

In cases were the physical size of the tag is not negligible relative to the reading distance there is a need to compensate for the reading parallax of the tag array. This parallax can be calculated from the equation, Δx=f*d/z, were f is the optical focus of the array optics, d is the tag size and z is the reading distance. For example, a tag of 20 mm size, with an optical focus of 1.5 mm and a reading distance of 5 meters, has a six microns parallax FIG. 6B, shows a periodical barcode pattern that is compensated to adapt for the parallax of the predefined reading distance.

In accordance with another preferred embodiment of the present invention, the spatial information stored within the tag can be alternatively stored in a multi layered interference filter, and assigning to each angle of interrogating beam incidence, a different reflectance. This ensures that while the tag is in motion, the interrogating beam scans different angles of incidence and thus responds to the information coded within the tag.

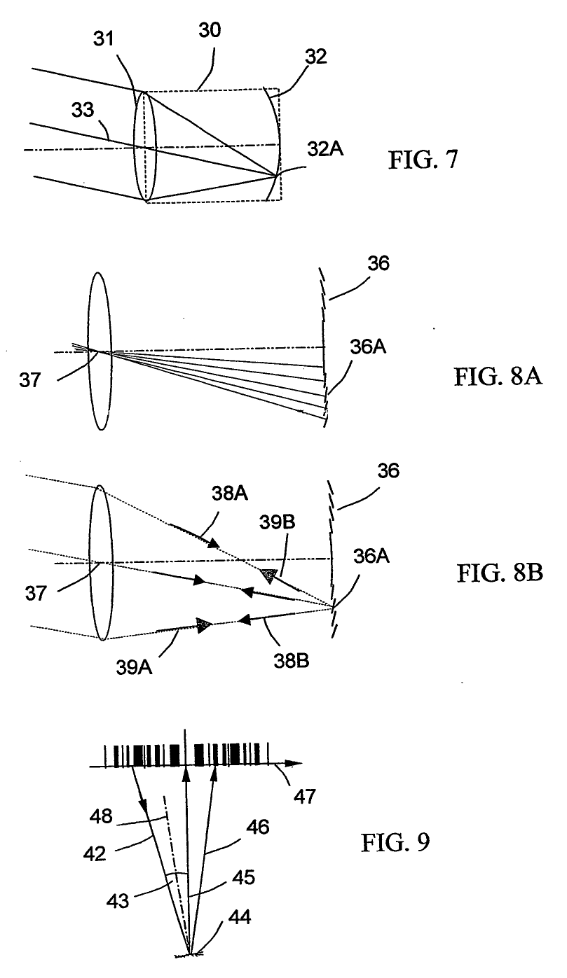

In accordance with another preferred embodiment of the present invention, FIG. 7 shows a detailed illustration of the optical tag configuration where the information plane 32 is curved along a sphere at the focal distance from the tag lens 31. Using this configuration, the focus point 32A, of the chief ray 33, is adequately focused for each direction the tag is interrogated. This embodiment represents another option to the use of DOE for the minimization of comma The present invention provides for a system that can be used in severe lighting conditions, utilizing a retroreflective tag that, together with active illumination with monochromatic light and a suitable filtered imaging device, can suppress spurious light sources and enhance the tag reflective light. FIGS. 8A and B shows a further preferred configuration of the retro-reflective tag. FIG. 8A shows the tag's back plane, made of multiple micro-mirrors, 36, each is directed towards the tag lens's center, 37. The beam shown in FIG. 8B, spanning from ray 38A to ray 39A, is focused at the tag back plane at point 36A, is mirror-imaged and reflected back onto itself, thus being retro-reflected. Ray 38A is reflected to ray 38B that is on the same path but opposite to ray 39A. Ray 39A in its turn, is reflected back to the same path as ray 38A but to the opposite direction.

FIG. 9 shows a single surface tag that is constructed of a single surface DOE, 44, to encode the angular reflection spectrum of a barcode, 47. The DOE is preferably constructed of a lens and a combination of diffraction gratings, each one have a pre specified cycle frequency and thus having a consequent diffraction direction. Together, the lines create the characteristically barcode lines. The lens is designed to focus the reader's radiation back to its origin and even more importantly, bring closer the Fraunhofer diffraction pattern, located typically at large distances, so it can be observed by the reader, as known in the art (Introduction to Fourier Optics/Joseph W. Goodman, p. 61, 83-86). The reader illuminates the tag from direction 42. Thus, the main specular reflection, 45, comes from the opposite side of the DOE optical axis and the diffracted rays, 46, construct the angular spectrum, 47, of the DOE, spanning both sides of the main reflection, 45. It should be noted that the reader, located in direction 42, because of its relative motion with respect to the DOE, temporally samples the diffraction spectrum across the whole of the diffracted light angle.

In accordance with another preferred embodiment of the present invention, the location of the image of each line of the tag's information plane is proportional to its location within the information plane and the tag's focus length, and is not affected by the velocity of the tag or its acceleration. Thus the image acquisitioned by the reader's camera is robust to change in tag velocities even at high relative velocities, or in the presence of tag accelerations. However, the light integration of the camera's detector is affected by the tag's velocity. At high tag velocities, the light response is smaller. This problem is easily solved using tag reflective enhancement properties and further selecting high-powered light source.

In accordance with another preferred embodiment of the present invention, the present invention provides means to handle dirt and smudge in the optical path, by locating the tag near the front windshield so that if it is covered, this is a sign that the driving visibility is also degraded and steps will be taken to rectify the situation. In order to further resolve the situation, more tags can be affixed to the front windshield such that all of them are read simultaneously in order to gain redundancy. Furthermore, the reader light source can be made adaptive to the weather conditions since drivers do not see infrared light and there is no radiation hazard using this band. Furthermore, in poor weather conditions, vehicles usually reduce their speed thus compensating for the poor visibility.

In accordance with another preferred embodiment of the present invention, the suppression of spurious light sources is very high relative to the reflectivity of the tag. This is made possible by the high reflective efficiency of the tags and the monochromatic and polarization filtering of the reader.

In accordance with another preferred embodiment of the present invention, the present invention provides for covert operation using light in the infrared region.

In accordance with another preferred embodiment of the present invention, the present invention provides for automatic and remote certification of tagged objects using special optical means to prevent counterfeiting, as is known in the art.

In accordance with another preferred embodiment of the present invention, the present invention provides for a system that can be read from relatively large distances, utilizing a retroreflective tag and bore sight arrangement of the reader's light source and the reader's imaging device. In systems necessitating large tag distances, the tag reflective efficiency can be improved by selecting larger tag aperture diameters.

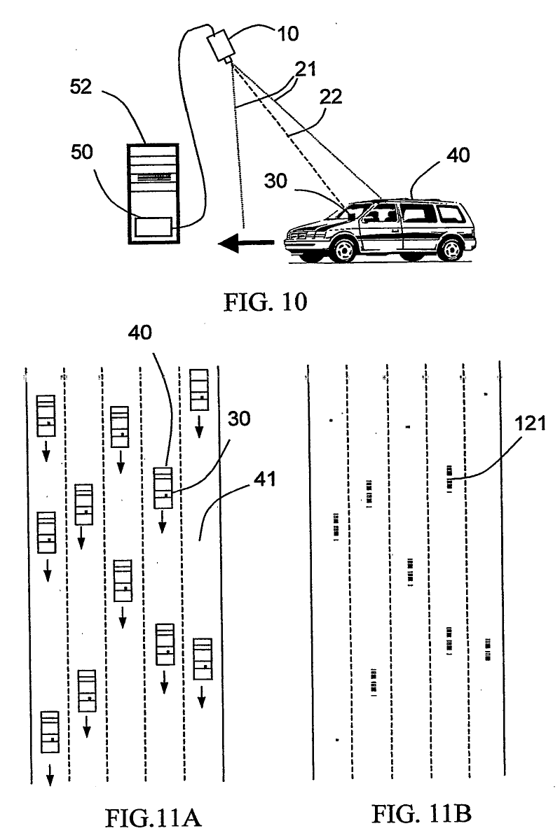

FIG. 10 shows an overall illustration of the preferred embodiment of the invention being used to identify moving objects or vehicles, 40, in accordance with an embodiment of the present invention. The reader, 10, may be installed on top or on the side of the path of the object, 40. The object may be a vehicle. The tag, 30, positioned on the vehicle, is read by the reader, 10, and then further transferred to a controller, 52, for further processing. The controller, 52, may comprise a host computer and a video frame grabber, 50.

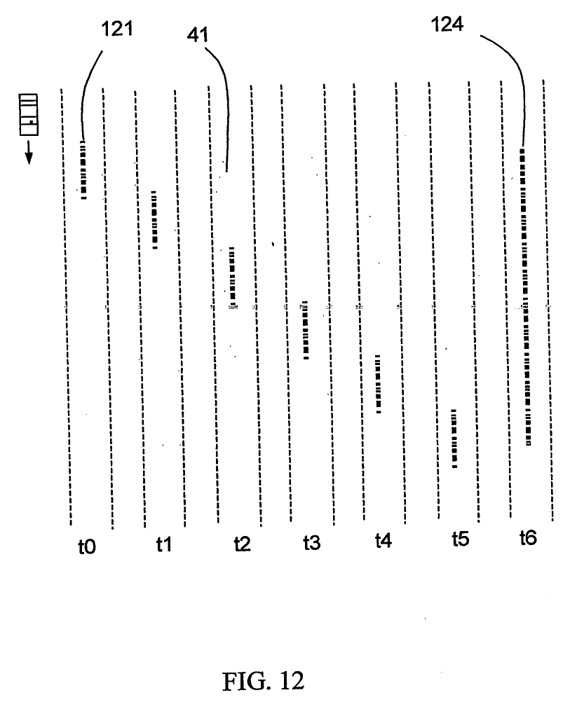

FIG. 11A shows a schematic illustration of the scene viewed by the reader imager, showing the tagged objects or vehicles in motion, 40, in accordance with another preferred embodiment of the present invention. The objects, 40, carry tags, 30, and move along the read zone, 41, of the reader.

FIG. 11B shows a schematic illustration relating to the filtered image acquisitioned by the reader's video imager showing the tag retroreflective responses, 121, in accordance with another preferred embodiment of the present invention.

FIG. 12 shows a schematic illustration depicting the process of accumulating the tag data in the reader, in accordance with another preferred embodiment of the present invention. In each video frame of the reader, the tag's response, 121, is identified and then accumulated to form the accumulated image of the barcode, 124.

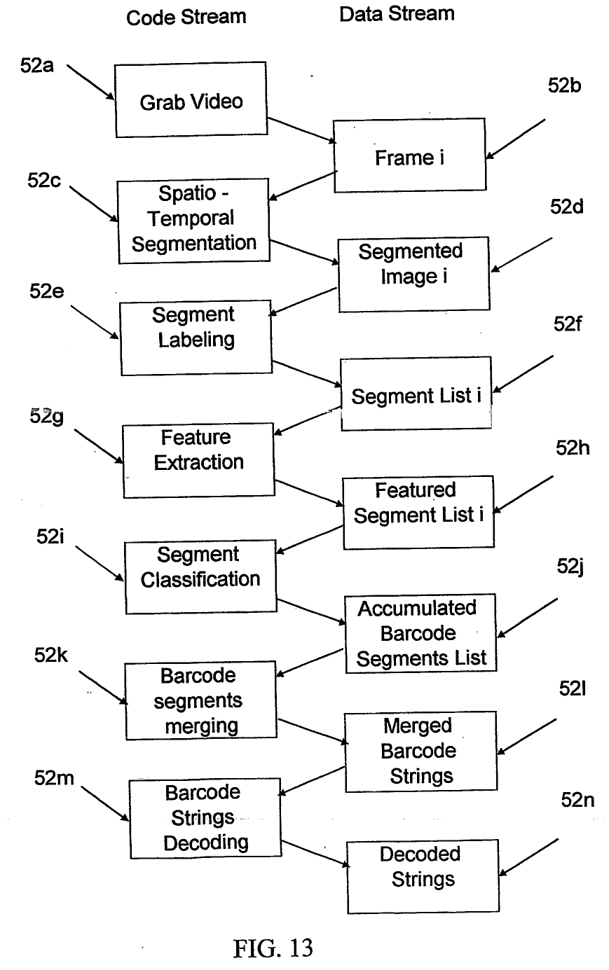

FIG. 13 shows a block diagram depicting code and data flow of the signal processing process, in accordance with another preferred embodiment of the present invention.

All the processing of this invention is digital processing. Grabbing an image by the camera, such as those of the apparatus of this invention, generates a sample image on the focal plane, which sampled image is preferably, but not a two-dimensional array of pixels, wherein to each pixel is associated a value that represents the radiation intensity value of the corresponding point of the image. For example, the radiation intensity value of a pixel may be from 0 to 255 in gray scale, wherein 0=black, 255=white, and others value between 0 to 255 represent different levels of gray. The two-dimensional array of pixels, therefore, is represented by a matrix consisting of an array of radiation intensity values.

Hereinafter, when an image is mentioned, it should be understood that reference is made not to the image generated by a camera, but to the corresponding matrix of pixel radiation intensities.

Each sampled image is provided with a corresponding coordinates system, the origin of which is preferably located at the center of the sampled image.

In order to adequately describe the algorithm description following, a number of definitions are necessary:

Pixel Segment is a group of connected pixels sharing common features or a group of features.

Segment labeling is the process of assigning each pixel in the image with a value of the segment to which the pixel belongs.

Segment feature extraction procedure is the process that assigns to each segment its features, such as segment area or number of pixels, segment mass, which is the sum of the pixel's gray levels, segment various moments, such as the moment of inertia, etc.

Segment classification procedure is the process of assigning a class or type to a segment according to the amount of resemblance of its features to the known features of the various classes.

Temporally accumulated barcode segment list is the list of all barcode-classified segments from all frames; each segment is stored with its features and its video frame origin.

Frame i, 52b, is grabbed within the frame sequence 52a. In frame i, the various segments of pixels are segmented using spatio-temporal filtering 52c as well as morphological filtering to form the segmented image i, 52d, as is known in the art. The various segments are then labeled, 52e, to form the segment list i, 52f. To each segment a feature extraction procedure, 52g, is than applied to form the featured segmented list i, 52h, as is known in the art. A segment classification procedure is than applied to distinguish the signal segments from the spurious noise segments to form the temporally accumulated barcode segment list 52j, as is known in the art. The barcode segments, 52j, are then merged, 52k, using the segments features, such as their locations etc. to form the merged barcode strings, 52l. Each barcode string is than decoded, 52m, to form the decoded tag information, 52n.

The information content of the tag is limited by the spot size of the optical system of the tag and the size of the information plane. The actual capacity in bits, or the number of resolvable barcode lines is the ratio of the information plane length to the lens focus spot width.

In accordance with another preferred embodiment of the present invention, the unique spatio-temporal behavior of the tag is utilized to automatically detect its presence within the field of view of the reader. As the moving tag enters the reader's field of view, it will be seen flickering and thus its detection and the initiation of decoding can be done automatically.

In accordance with another preferred embodiment of the present invention, the sampling of the barcode signal is done in the reader camera. Generally, spatio-temporal sampling is sought; both spatial and temporal samplings are needed for simultaneous tag reading without cross talk between their respective signals. There are some tradeoffs between the spatial and the temporal sampling of the signal according to the information merits needed. The tag position can be sampled by the spatial sampling alone while the tag's information content may be sampled both spatially and temporally. Thus, the combined spatio-temporal sampling scheme resolves both the tag's information content and the position vector of the tag. The position vector provides the tag location; its temporal derivative provides the tag's speed and its scalar multiplication with the reader's direction of viewing vector provides the tag's relative angle to the reader's viewing direction The simplest situation of tag reading is the case where there is no need to resolve its position and there is only one tag that may be present at a time. In this situation, temporal sampling alone is sufficient. This sampling scheme results in relatively simple signal acquisition and processing where the reader's imaging plane is preferably comprised of a single detector, usually a single photodiode. In other cases where the tag position is needed or there may be more than just one tag present in front of the reader, spatial sampling is needed as well. In cases where the position determination is needed at relatively high resolution, the spatial resolution alone may resolve both the tag's information and position. In this case, the number of pixels in the sampling matrix limits the information content that can be resolved. In yet another case where the tagged objects are moving along a distinct line, the sampling may be one dimensional, e.g. a linear array of pixels.

I claim:

1. A method for determining information relating to an object in relative motion to a given point, comprising the steps of:
generating a beam of radiation at said given point;
providing said object with spatially coded information;
directing said beam of radiation at said object;
scanning said spatially coded information by means of the relative motion of the object and the beam such that said spatially coded information is converted into temporally coded information;
imaging a beam of radiation retro-reflected from said object to said given point; and
determining said temporally coded information from at least one image generated in said imaging step.

2. The method of claim 1, wherein said information is related to at least one of the identity, vector position, and relative velocity of said object.

3. The method of claim 1, wherein said relative motion is generated by either one of motion of said object and said given point.

4. The method of claim 1, wherein said beam of radiation is selected from a group consisting of a continuous beam, a pulsed beam and an infra red beam.

5. The method of claim 1, wherein said imaging is performed by means of a video imager.

6. The method of claim 1, wherein said determining is performed by means of image processing of said image.

7. The method of claim 1, wherein said beam of radiation directed at said object and said beam of radiation retro-reflected from said object utilize optics having essentially the same numerical aperture.

8. The method of claim 1 and wherein said spatially coded information is disposed on a tag.

9. The method of claim 8 and wherein said tag has an imaging surface and an information plane surface.

10. The method of claim 8 and wherein said tag has a single surface operative to encode the angular reflection spectrum of said information.

11. The method of claim 8 and wherein said tag has a rear surface comprising either one of multiple micro-mirrors and a retroreflective sheet.

12. The method of claim 1 and wherein said spatially coded information is disposed on a curved surface.

13. The method of claim 8 and wherein said spatially coded information comprises a barcode.

14. The method of claim 13 and wherein said barcode has a circular pattern.

15. The method of claim 13 and wherein said spatially coded information is color coded information, such that each reading angle is related to a different color.

16. The method of claim 8 wherein said tag is reflective.

17. The method of claim 1 and wherein said vector position comprises at least one of the rectilinear location and the angular location of said object relative to said given point.

18. The method of claim 1 and wherein said step of scanning said spatially coded information is performed by imaging said beam of radiation through at least one optical element onto said coded information.

19. The method of claim 18 and wherein said at least one optical element is selected from the group consisting of at least one lens, at least one diffractive optical element and at least one lenslet array.

20. The method of claim 19 and wherein said at least one lenslet array has essentially the same period as the periodical pattern of information on said tag.

21. The method of claim 19 and wherein said at least one lenslet array has a smaller period than the periodical pattern of information on said tag, such that said retroreflected beam converges essentially to said given point.

22. The method of claim 21 and wherein said periodical pattern of information can be aligned relative to said at least one lenslet array using a set of markers in predefined locations on said periodical pattern.

23. The method of claim 18 and wherein said at least one optical element provides multiple encoding of said retroreflected beam such that said spatially coded information can be optically certified.

24. The method of claim 18 and wherein said imaging of said radiation retro-reflected from said object is performed by means of an imaging element having essentially the same numerical aperture as that of said optical element.

25. The method of claim 1 and wherein said beam of radiation comprises wavelengths in the infrared spectrum.

26. The method of claim 8 and wherein said tag is carried by either one of a person in motion and an object in motion.

27. The method of claim 8 and wherein said tag is attached to an object in motion.

28. The method according to claim 27 and wherein said object is a vehicle.

29. The method according to claim 1 and wherein said continuous beam of radiation is linearly polarized, and wherein said step of imaging said beam of retro-reflected radiation is performed through a linear polarizer.

30. The method according to claim 1 and wherein said beam of radiation is monochromatic and wherein said step of imaging said beam of retro-reflected radiation is performed through a color filter.

31. The method according to claim 8 and wherein said tag is provided with information stored in a multi layered interference filter assigning each angle of interrogating beam incidence a different reflectance.

32. The method according to claim 1 wherein said beam of radiation is generated from a source essentially coaxial with said imager.

33. The method according to claim 32 and wherein said source is selected from a group consisting of a laser, a collimated source and the output from the end of an optical fiber.

34. The method according to claim 33 and wherein said end of said optical fiber is disposed at the center of said imaging element.

35. The method according to claim 33 and wherein said end of said optical fiber is disposed on the optical axis of said imaging element.

36. The method according to claim 32 and wherein said source is a plurality of sources disposed around the periphery of said imaging element.

37. The method according to claim 36 and wherein said source is a pair of diametrically opposite sources.

38. The method according to claim 36 and also comprising the step of generating at least a second beam of radiation at a second given point, such that multiple sets of spatially coded information on an object can be simultaneously scanned.

39. A system for determining spatially coded information relating to an object in relative motion to a given point, comprising:
a source producing a beam of radiation at said given point;
at least one optical element adapted to image part of said beam of radiation onto said spatially coded information, and to collect part of said beam reflected from said spatially coded information;
an imaging element adapted to generate an image of said collected part of said beam reflected from said spatially coded information; and
an image processor determining said temporally coded information from said image generated by said imaging element.

40. The system of claim 39, wherein said beam of radiation is selected from a group consisting of a continuous beam, a pulsed beam and an infra red radiation beam.

41. The system of claim 39, wherein said image is captured by means of a video imager.

42. The system of claim 39, wherein said optical element and said imaging element have essentially the same numerical aperture.

43. The system of claim 42, wherein said source also has essentially the same numerical aperture as said optical element and said imaging element.

44. The system of claim 39 and wherein said spatially coded information is disposed on a tag.

45. The system of claim 44 and wherein said tag has a imaging surface and an information plane surface.

46. The system of claim 44 and wherein said tag has a single surface operative to encode the angular reflection spectrum of said information.

47. The system of claim 44 and wherein said tag has a rear surface comprising of any one of multiple micro-mirrors and a retroreflective sheet.

48. The system of claim 39 and wherein said spatially coded information is disposed on a curved surface.

49. The system of claim 44 and wherein said spatially coded information comprises a barcode.

50. The system of claim 49 and wherein said barcode has a circular pattern.

51. The system of claim 49 and wherein said spatially coded information is color coded information, such that each reading angle is related to a different color.

52. The system of claim 44 and wherein said tag is reflective.

53. The system of claim 39 and wherein said at least one optical element is selected from a group consisting of at least one lens, at least one diffractive optical element and at least one lenslet array.

54. The system of claim 53 and wherein said at least one lenslet array has essentially the same period as the periodical pattern of information on said tag.

55. The system of claim 53 and wherein said at least one lenslet array has a smaller period than the periodical pattern of information on said tag, such that said reflected beam converges essentially to said given point.

56. The system of claim 53 and wherein said periodical pattern of information can be aligned relative to said at least one lenslet array using a set of markers in predefined locations on said periodical pattern.

57. The system of claim 39 and wherein said at least one optical element is adapted to provide multiple encoding of said reflected beam such that said spatially coded information can be optically certified.

58. The system of claim 39 and wherein said beam of radiation comprises wavelengths in the infrared spectrum.

59. The system according to claim 44 and wherein said tag is carried by either one of a person in motion and an object in motion.

60. The system according to claim 59 and wherein said object is a vehicle.

61. The system according to claim 39 and wherein said continuous beam of radiation is linearly polarized, and also comprising a linear polarizer disposed before said imaging element.

62. The system according to claim 39 and wherein said beam of radiation is monochromatic and also comprising a color filter disposed before said imaging element.

63. The system according to claim 44 and wherein said tag is provided with information stored in a multi layered interference filter assigning each angle of interrogating beam incidence a different reflectance.

64. The system according to claim 39 wherein said beam of radiation is generated from a source essentially coaxial with said imager.

65. The system according to claim 64 and wherein said source is selected from the group consisting of a laser, a collimated source and the output from the end of an optical fiber.

66. The system according to claim 65 and wherein said end of said optical fiber is disposed at the center of said imaging element.

67. The system according to claim 65 and wherein said end of said optical fiber is disposed on the optical axis of said imaging element.

68. The system according to claim 64 and wherein said source is a plurality of sources disposed around the periphery of said imaging element.

69. The system according to claim 68 and wherein said source is a pair of diametrically opposite sources.

70. The system according to claim 68 and also comprising at least a second beam of radiation at a second given point, such that multiple sets of spatially coded information on an object can be simultaneously scanned.
